(19) United States
(12) Patent Application Publication
(10) Pub. No.: US 2009/0293662 A1
(43) Pub. Date: Dec. 3, 2009

(54) TRANSMISSION

(76) Inventors: Ryo Terada, Kawasaki (JP); Toshikuni Shirasawa, Kawasaki (JP)

Correspondence Address: JACOBSON HOLMAN PLLC, 400 SEVENTH STREET N.W., SUITE 600, WASHINGTON, DC, 20004, US

(21) Appl. No.: 12/309,968

(22) PCT Filed: Jul. 27, 2007
(86) PCT No.: PCT/JP2007/064752

§ 371 Date: Feb. 5, 2009

(30) Foreign Application Priority Data
Aug. 16, 2006 (JP) 2006-221916

(51) Int. Cl. G05G 5/08

(52) U.S. Cl. 74/473.25

(57) ABSTRACT

A transmission capable of preventing situations in which an inappropriate gear is selected is provided while suppressing increases in the size of the transmission. Movement of gear change members for selecting a gear in a shifting direction is inhibited by inhibiting members provided on the outer sides of both ends of the gear change members, and the inhibiting members are provided with grooves that allow a gear change member that is engaged with a shift operating member to move in the shifting direction. Recess portions of the gear change members allow the inhibiting members to move in a selecting direction when the gear change members are in a gear selective position. Movement of the gear change member that is in the gear selective position and not engaged with the shift operating member to a gear non-selective position is inhibited by an engagement between the inhibiting member and the recess portion.

This is a national stage of PCT/JP07/064,752 filed Jul. 27, 2007 and published in Japanese, which has a priority of Japanese no. 2006-221916 filed Aug. 16, 2006, hereby incorporated by reference.

### TECHNICAL FIELD

The present invention relates to a transmission, and more particularly to a transmission capable of changing gears by selecting and operating a gear change member using a shift operating member.

### BACKGROUND ART

In a conventional so-called parallel shaft-type manual transmission serving as a transmission installed in a vehicle and having a plurality of gears between an input shaft and an output shaft provided in parallel with each other, a gear change is performed by selecting and operating a gear change member such as a shift rail, or a shift jaw or shift fork provided slidably on the shift rail, using a shift operating member that operates in conjunction with a shift lever operated by a driver. Transmissions in which such gear changes are performed automatically have also been developed and put to practical use.

When a gear change is performed in a parallel shaft-type automatic transmission, a state in which two gears are selected simultaneously on a single input shaft cannot be set, and therefore the currently selected and meshed gear is first disengaged, and then a new gear is selected. However, when performing this type of gear change, driving force transmission from a power source to the transmission is temporarily shut off, and as a result, driving force is not transmitted continuously to the drive wheels even when the driver presses an accelerator pedal. This leads to deterioration of the drivability.

To solve this problem, a so-called double clutch transmission has been developed, in which a first gear mechanism having a plurality of gears is provided between a first input shaft and an output shaft and a second gear mechanism having a plurality of gears is provided between a second input shaft and the output shaft so that driving force from a power source can be transmitted to the first input shaft via a first clutch and this driving force can be transmitted to the second input shaft via a second clutch.

In this double clutch transmission, when a gear of the first gear mechanism is selected such that the driving force from the power source is transmitted to the first input shaft via the first clutch, for example, the second clutch is disengaged such that the driving force from the power source is not transmitted to the second input shaft. At this time, in the second gear mechanism, the predicted gear of the next gear change is selected and meshed in advance such that when a gear change instruction is issued, the second clutch is engaged while disengaging the first clutch, and as a result, power transmission to the drive wheels is performed continuously, thereby improving the drivability.

Likewise in a double clutch transmission, a mechanism in which a gear change member is selected and operated by a shift operating member, such as that described above, is used as the mechanism for performing this type of gear change, and the shift operating member is operated by an actuator.

More specifically, a plurality of shift forks serving as gear change members are disposed close to each other in engaging positions for engaging with a shift operating member, and by engaging an engaging portion of the shift operating member with one of U-shaped notches formed in each shift fork and swinging the shift operating member in a shifting direction, the shift fork is moved in the shifting direction, enabling selection of the corresponding gear.

However, in this type of mechanism, there is no device for actively inhibiting shifting direction movement of a different shift fork to the shift fork corresponding to the gear to be selected, and therefore a situation in which the shift forks move in the shifting direction for some reason such that a different gear to the gear to be selected is unintentionally selected at the same time may occur.

With respect to the currently selected gear, a similar situation in which the shift fork corresponding to the currently selected gear returns to a neutral position, i.e. a gear non-selective position, for some reason may occur.

To solve these problems, Japanese Unexamined Patent Application Publication 2006-2789 (herein after referred to as “Patent Document 1”) proposes a transmission comprising an interlocking mechanism for preventing a shift fork from moving inappropriately in the shifting direction.

FIG. 11 is a schematic diagram showing the basic structure of the interlocking mechanism in the transmission of Patent Document 1.

As shown in FIG. 11, a plurality of shift forks 201, 202, 203, 204 serving as gear change members are disposed close to each other in engaging positions for engaging with a shift operating member, and by moving one of these shift forks 201, 202, 203, 204 in a shifting direction, indicated by an arrow SF in FIG. 11, to a gear selective position abutting a stopper 205 or a stopper 206, a corresponding gear can be selected.

U-shaped notches 207, 208, 209, 210 are formed respectively in the shift forks 201, 202, 203, 204, and one of the shift forks is selected by moving an engaging portion 211 formed on an end portion of the shift operating member in a selecting direction (indicated by an arrow SL in FIG. 11), which is perpendicular to the shifting direction, within the notches 207, 208, 209, 210. Then, by swinging the shift operating member such that the engaging portion 211 moves in the shifting direction, the selected shift fork is moved to the gear selective position abutting one of the stoppers 205 and 206 provided on either side, and as a result, a gear is selected.

An inhibiting member 212 for inhibiting shifting direction movement of the shift forks 201, 202, 203, 204 is provided as the interlocking mechanism.

As shown in FIG. 11, the inhibiting member 212 inhibits shifting direction movement of the shift forks 201, 202, 203, 204 by abutting against the shift forks 201, 202, 203, 204 within the notches 207, 208, 209, 210 of the shift forks 201, 202, 203, 204.

Gaps 213, 214 are formed in the inhibiting member 212, and the inhibiting member 212 is movable in the selecting direction in conjunction with the selecting direction movement of the engaging portion 211. By means of the gaps 213, 214, only the shift fork that is engaged with the engaging portion 211 is allowed to move in the shifting direction at all times without being inhibited by the inhibiting member 212.

FIG. 11 shows a neutral state in which all of the shift forks 201, 202, 203, 204 are in the gear non-selective position which is the middle position between the stoppers 205 and 206 on either side such that no gear is selected.

By selecting one shift fork corresponding to a gear of the first gear mechanism and one shift fork corresponding to a gear of the second gear mechanism from among the shift forks 201, 202, 203, 204 and moving the selected shift forks in the shifting direction from this state to the gear selective position, a gear of the first gear mechanism and a gear of the second gear mechanism can be selected simultaneously.

FIG. 12 shows an example in which the shift fork 202 has been moved in the shifting direction to the gear selective position abutting the stopper 205 to select a gear of the first gear mechanism, and the shift fork 203 has been moved in the shifting direction to the gear selective position abutting the stopper 206 to select a gear of the second gear mechanism.

As shown in FIG. 12, when the shift fork 202 selects a gear of the first gear mechanism, the shift fork 202 has been moved to the stopper 205 side to a position in which the inhibiting member 212 can pass the outside of the end portion of the shift fork 202 on the stopper 206 side, and when the shift fork 203 selects a gear of the second gear mechanism, the shift fork 203 has been moved to the stopper 206 side to a position in which the inhibiting member 212 can pass the outside of the end portion of the shift fork 203 on the stopper 205 side.

Hence, when one of the shift forks 201, 202, 203, 204 has been moved to the gear selective position in the shifting direction, the inhibiting member 212 moves in conjunction with the selecting direction movement of the engaging portion 211 so as to pass the shifting direction outside of the shift fork that is in the gear selective position, and as a result, shifting direction movement of the shift fork that is in the gear selective position at this time is inhibited by the inhibiting member 212.

In the case shown in FIG. 12, the stopper 206 side end portion of the shift fork 202, which is in the gear selective position abutting the stopper 205, abuts against the inhibiting member 212, and hence movement thereof to the gear non-selective position is inhibited. Furthermore, the inhibiting member 212 is disposed within the notches 207, 211 of the shift forks 201, 204 that are in the gear non-selective position, and therefore movement of the shift forks 201, 204 to the gear selective position is also inhibited.

On the other hand, the shift fork 203 is in the gear selective position and the engaging portion 211 is positioned inside the notch 203 thereof. Hence, the shift fork 203 is capable of moving in the shifting direction via the gaps 213, 214, and therefore, when the engaging portion 211 moves in the shifting direction, the shift fork 203 can move toward the stopper 205.

By providing the inhibiting member 212 as an interlocking mechanism, a situation in which a shift fork corresponding to a different gear to the gear to be selected moves unintentionally such that an unintended gear is selected, or a situation in which the shift fork corresponding to the currently selected gear returns to the neutral position, i.e. the gear non-selective position, can be prevented.

However, when this type of interlocking mechanism is provided, the inhibiting member 212 abuts against each of the shift forks 201, 202, 203, 204 within the notches 207, 208, 209, 210 formed in the shift forks 201, 202, 203, 204, as described above, and therefore, as shown in FIGS. 11 and 12, the shifting direction width of the notches must be increased greatly relative to the width of the engaging portion 211.

The width of the notches 207, 208, 209, 210 in the shifting direction must be made larger than the width of the engaging portion 211 in the shifting direction by at least an amount corresponding to the sum of the movement width of the shift fork 202 between the gear non-selective position and the gear selective position and the thickness of the inhibiting member 212 in the shifting direction, for example, so that the engaging portion 211 can be inserted between the inhibiting member 212 and the shift fork 202 even when the shift fork 202 is in the gear selective position, as shown in FIG. 12.

With the mechanism of FIG. 12 in particular, a shifting direction width L11 of the region in which the notches 207, 208, 209, 210 overlap each other in the selecting direction must be set larger than a shifting direction width L12 of the engaging portion 211 so that the engaging portion 211 is capable of moving in the selecting direction regardless of whether the shift forks 201, 202, 203, 204 are in the gear non-selective position or the gear selective position. Accordingly, the shifting direction width of the notches 207, 208, 209, 210 must be made even larger.

Since the shifting direction width of the notches 207, 208, 209, 210 must be increased in this manner, the shifting direction dimension of the shift forks 201, 202, 203, 204 increases correspondingly, and sufficient space must be provided to accommodate the shift forks 201, 202, 203, 204. Typically, the shifting direction corresponds to the lengthwise direction of the transmission, and therefore, to secure sufficient space for accommodating the shift forks 201, 202, 203, 204 having an enlarged shifting direction dimension, the transmission itself must be increased in length.

Furthermore, as described above, the shift forks 201, 202, 203, 204 are moved in the shifting direction by swinging the shift operating member, but since the shifting direction width of the notches 207, 208, 209, 210 is greater than the shifting direction width of the engaging portion 211, the movement distance of the engaging portion 211 must be increased by swinging the shift operating member widely. To maintain the engagement between the engaging portion 211 and the notch when the shift operating member is swung widely, the swinging radius of the shift operating member must be increased to reduce the up-down direction movement amount of the engaging portion 211, or the height of the notches 207, 208, 209, 210 must be increased.

Consequently, the height of the transmission is increased. Furthermore, when the swinging radius of the shift operating member is increased, the operating force required to operate the shift operating member increases, and therefore a larger actuator must be used.

### DISCLOSURE OF THE INVENTION

The present invention has been made in consideration of these problems, and it is an object thereof to provide a transmission capable of preventing situations in which an inappropriate gear is selected while suppressing increases in the size of the transmission.

To achieve this object, a transmission of the present invention comprises a plurality of gear change members arranged for moving from a gear non-selective position to a gear selective position in a predetermined shifting direction to select a gear of a transmission mechanism; a shift operating member capable of moving in a selecting direction perpendicular to the shifting direction to engage with one of the gear change members, and of causing the gear change member with which the shift operating member is engaged to move in the shifting direction; and a pair of inhibiting members disposed along the selecting direction on an outer side of each shifting direction end of each of the plurality of gear change members located in the gear non-selective position in order to be able to inhibit movement of the gear change members in the shifting direction, each inhibiting member being capable of moving in the selecting direction together with the shift operating member, and each inhibiting member being formed with a groove that allows the gear change member which is selected from among the plurality of gear change members and is engaged with the shift operating member to move in the shifting direction. Each of the gear change members is provided with recess portions which are arranged for allowing the pair of inhibiting members to move in the selecting direction when the corresponding gear change member is located in the gear selective position, and for inhibiting the corresponding gear change member from moving to the gear non-selective position by engaging with one of the inhibiting members when the corresponding gear change member is located in the gear selective position and not engaged with the shift operating member (claim 1).

In the transmission constituted in this manner, movement of a gear change member, which is not engaged with the shift operating member and is in the gear non-selective position, in the shifting direction is inhibited by the inhibiting members disposed on the two outer sides of both ends thereof in the shifting direction, and movement of a gear change member, which is not engaged with the shift operating member and is in the gear selective position, in the shifting direction is inhibited by engaging one of the recess portions provided in the concerned gear change member with one of the inhibiting members.

On the other hand, a gear change member that is engaged with the shift operating member can be moved in the shifting direction between the gear non-selective position and the gear selective position through one of the grooves formed in the inhibiting members by moving the shift operating member in the shifting direction.

Furthermore, the recess portions are provided in each gear change member, and as the shift operating member moves in the selecting direction, the inhibiting members move in the selecting direction together with the shift operating member through the recess portions of the gear change members located in the gear selective position.

Hence, the inhibiting members move in the selecting direction while inhibiting movement of each gear change member in the shifting direction, and since the grooves of the inhibiting members move in the selecting direction together with the shift operating member, the inhibiting members allow a gear change member that is engaged with the shift operating member following movement of the shift operating member in the selecting direction to move in the shifting direction through one of the grooves.

Furthermore, in the transmission described above, the shift operating member comprises an engaging portion arranged for engaging with one of the gear change members, and a notch is provided in each of the gear change members for enabling passage of the engaging portion therethrough when the shift operating member moves in the selecting direction and for engaging with the engaging portion when the shift operating member moves in the shifting direction, wherein a width of each of the notches in the shifting direction is set to be larger than, and similar to, a width of the engaging portion in the shifting direction so that the engaging portion can be fitted into the notch with play remaining (claim 2).

In the transmission constituted in this manner, the width of the notch in the shifting direction is larger than, and similar to, the width of the engaging portion in the shifting direction. Therefore, the engaging portion of the shift operating member can move in the selecting direction through the notches and be fitted into one of the notches with play remaining, whereby the gear change members can be moved in the shifting direction.

Further, in the transmission described above, the transmission mechanism comprises a first input shaft to which a driving force from a power source is transmitted via a first clutch; a second input shaft to which the driving force is transmitted via a second clutch; an output shaft arranged for outputting the driving force following speed shifting thereof; a first gear mechanism provided between the first input shaft and the output shaft, and having a plurality of gears; and a second gear mechanism provided between the second input shaft and the output shaft, and having a plurality of gears. The gear change members are constituted by a first gear change member arranged for selecting a gear of the first gear mechanism, and a second gear change member arranged for selecting a gear of the second gear mechanism (claim 3).

In the transmission constituted in this manner, a gear of the first gear mechanism is selected by engaging the shift operating member with the first gear change member and moving the shift operating member in the shifting direction. Also, a gear of the second gear mechanism is selected by engaging the shift operating member with the second gear change member and moving the shift operating member in the shifting direction.

When a gear is selected in this manner and the first clutch is engaged, the driving force from the power source is transmitted to the first input shaft via the first clutch, subjected to speed shifting via the selected gear of the first gear mechanism, and then output from the output shaft. At this time, the second clutch is disengaged such that the driving force of the power source is not transmitted to the second input shaft, and therefore driving force transmission from the gear selected in the second gear mechanism to the output shaft is not performed.

When the second clutch is engaged, the driving force from the power source is transmitted to the second input shaft via the second clutch, subjected to speed shifting via the selected gear of the second gear mechanism, and then output from the output shaft. By disengaging the first clutch at this time, the driving force of the power source is prevented from being transmitted to the first input shaft, and therefore driving force transmission from the gear selected in the first gear mechanism to the output shaft is not performed.

In the transmission of the present invention, movement of a gear change member, which is not engaged with the shift operating member and is in the gear non-selective position, in the shifting direction is inhibited by inhibiting members disposed on the two outer side of both ends thereof in the shifting direction, and movement of a gear change member, which is engaged with the shift operation member and is in the gear selective position, in the shifting direction is inhibited by engaging one of the recess portions provided in the concerned gear change member with one of the inhibiting members. Therefore, situations in which an incorrect gear is selected due to movement of a gear change member that should not be moved or a selected gear is disengaged mistakenly can be prevented.

Furthermore, the inhibiting members are disposed on the outer sides of both ends of the gear change members in the shifting direction, and therefore the need to increase the length of the gear change members by an amount corresponding to the sum of the movement width of the gear change members between the gear non-selective position and the gear selective position and the shifting direction thickness of the inhibiting members, as is the case where the inhibiting members are disposed in the notches formed in the gear change members when the gear change members are located in the gear non-selective position, can be eliminated.

Hence, the shifting direction dimension of the gear change members can be shortened, enabling a reduction in the shifting direction space required to accommodate the gear change members and ensuring that increases in the length of the transmission can be prevented.

In the transmission according to claim 2, the width of the notch in the shifting direction is larger than, and similar to, the width of the engaging portion in the shifting direction, and therefore the shifting direction dimension of each gear change member can be suppressed to the required minimum.

In addition to this effect, in a case where the shift operating member is swung in the shifting direction in order to move the gear change members in the shifting direction using the engaging portion, the shifting direction play between the engaging portion and the engaged notch of the gear change member is small, and therefore the swinging radius of the shift operating member can be shortened. As a result, increases in the height direction size of the transmission can be prevented, and the operating force required to operate the shift operating member can be reduced, which can downsize the actuator for operating the shift operating member.

In the transmission according to claim 3, a gear of the first gear mechanism is selected by engaging the shift operating member with the first gear change member and moving the shift operating member in the shifting direction. Also, a gear of the second gear mechanism is selected by engaging the shift operating member with the second gear change member and moving the shift operating member in the shifting direction.

Hence, by engaging the first clutch and disengaging the second clutch, the driving force from the power source can be transmitted to the first input shaft via the first clutch, subjected to speed shifting via the selected gear of the first gear mechanism, and then output from the output shaft.

On the other hand, by engaging the second clutch and disengaging the first clutch, the driving force from the power source can be transmitted to the second input shaft via the second clutch, subjected to speed shifting via the selected gear of the second gear mechanism, and then output from the output shaft.

When switching from a gear selected in the first gear mechanism to a gear selected in the second gear mechanism, the second clutch is engaged while disengaging the first clutch such that the driving force can be output from the output shaft continuously, and in so doing, the drivability during a gear change can be improved.

Further, when switching from a gear selected in the second gear mechanism to a gear selected in the first gear mechanism, the first clutch is engaged while disengaging the second clutch such that the driving force can be output from the output shaft continuously, and in so doing, the drivability during a gear change can be improved.

### BRIEF DESCRIPTION OF THE DRAWINGS

FIG. 1 is a skeleton diagram of a transmission according to one embodiment of the present invention;

FIG. 2 is a schematic sectional view of a mechanism for selectively moving sleeves of a transmission mechanism to select a corresponding gear, seen from the front side of a vehicle;

FIG. 3 is a sectional view along a line III-III in FIG. 2;

FIG. 4 is a view showing a state in which a shift lever of FIG. 3 is swung;

FIG. 5 is a schematic diagram showing the main parts of the mechanism of FIG. 2, seen from above, in a case where the transmission mechanism is in a neutral state;

FIG. 6 is a schematic diagram showing the main parts of the mechanism of FIG. 2, seen from above, in a case where a first gear has been selected and an engaging portion is moving;

FIG. 7 is a schematic diagram showing the main parts of the mechanism of FIG. 2, seen from above, in a case where the first gear has been selected and the engaging portion is fitted into a notch of a second shift jaw with play remaining;

FIG. 8 is a schematic diagram showing the main parts of the mechanism of FIG. 2, seen from above, in a case where a fourth gear has been selected and the engaging portion is fitted into the notch of the second shift jaw with play remaining;

FIG. 9 is a schematic diagram showing the main parts of the mechanism of FIG. 2, seen from above, in a case where the fourth gear has been selected and the engaging portion is fitted into the notch of a third shift jaw with play remaining;

FIG. 10 is a schematic diagram showing the main parts of the mechanism of FIG. 2, seen from above, in a case where a third gear and the fourth gear have been selected and the engaging portion is fitted into the notch of the second shift jaw with play remaining;

FIG. 11 is a schematic diagram showing an interlocking mechanism in a conventional transmission; and

FIG. 12 is a schematic diagram showing the interlocking mechanism of the transmission shown in FIG. 11 when two gears have been selected.

### BEST MODE OF CARRYING OUT THE INVENTION

A transmission according to one embodiment of the present invention will be described below with reference to the drawings.

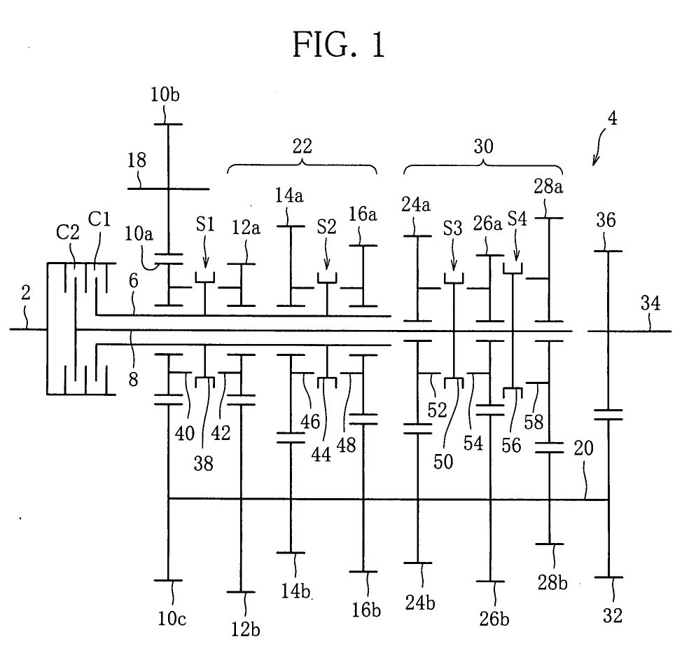

FIG. 1 is a skeleton diagram of a transmission installed in a vehicle. An input side of a first clutch C1 and a second clutch C2 is connected to an output shaft of an engine (not shown) serving as a power source via a shared clutch input shaft 2. Further, an output side of the first clutch C1 is connected to a first input shaft 6 of a transmission mechanism 4, while an output side of the second clutch C2 is connected to a second input shaft 8. The first input shaft 6 is provided coaxially with and on the outside of the second input shaft 8, and the first input shaft 6 and second input shaft 8 are capable of rotating independently of each other.

Further, the first clutch C1 and second clutch C2 are arranged to be engaged and disengaged independently by a clutch actuator, not shown in the drawing.

A reverse drive gear 10a, a first speed drive gear 12a, a fifth speed drive gear 14a, and a third speed drive gear 16a are provided on the first input shaft 6 in this order from the side of the first clutch C1 so as to be capable of rotating relative to the first input shaft 6.

A reverse idler gear 10b that meshes with the reverse drive gear 10a at all times is fixed to an idler shaft 18 disposed parallel to the first input shaft 6 and second input shaft 8, and the reverse idler gear 10b always meshes with a reverse driven gear 10c fixed to a countershaft 20, which is disposed parallel to the first input shaft 6 and second input shaft 8.

A first speed driven gear 12b that meshes with the first speed drive gear 12a at all times, a fifth speed driven gear 14b that meshes with the fifth speed drive gear 14a at all times, and a third speed driven gear 16b that meshes with the third speed drive gear 16a at all times are fixed to the countershaft 20, and a first gear mechanism 22 is constituted by the three pairs of drive gears 12a, 14a, 16a and driven gears 12b, 14b, 16b.

Meanwhile, a fourth speed drive gear 24a, a second speed drive gear 26a, and a sixth speed drive gear 28a are provided on the second input shaft 8 in this order from the side of the second clutch C2 so as to be capable of rotating relative to the second input shaft 8.

A fourth speed driven gear 24b that meshes with the fourth speed drive gear 24a at all times, a second speed driven gear 26b that meshes with the second speed drive gear 26a at all times, and a sixth speed driven gear 28b that meshes with the sixth speed drive gear 28a at all times are fixed to the countershaft 20, and a second gear mechanism 30 is constituted by the three pairs of drive gears 24a, 26a, 28a and driven gears 24b, 26b, 28b.

A counter gear 32 is fixed to an end portion of the countershaft 20 on the side of the sixth speed driven gear 28b, and the counter gear 32 always meshes with an output gear 36 fixed to an output shaft 34 of the transmission mechanism 4, whereby the driving force of the countershaft 20 is transmitted to the output shaft 34. The driving force output from the output shaft 34 is transmitted to drive wheels, not shown in the drawing, thereby causing the vehicle to travel.

A first synchromesh device S1 that rotates integrally with the first input shaft 6 is disposed between the reverse drive gear 10a and the first speed drive gear 12a, and a second synchromesh device S2 that rotates integrally with the first input shaft 6 is disposed between the fifth speed drive gear 14a and the third speed drive gear 16a.

The first synchromesh device S1 has a first sleeve 38 which is capable of sliding in an axial direction of the first input shaft 6, and when the first sleeve 38 moves to the side of the reverse drive gear 10a to engage with a reverse clutch gear 40 fixed to the reverse drive gear 10a, the reverse drive gear 10a is connected to the first input shaft 6 such that a reverse gear is selected.

In this case, when the first clutch C1 is engaged such that the driving force of the engine is transmitted to the first input shaft 6 from the clutch input shaft 2 via the first clutch C1, the driving force of the first input shaft 6 is transmitted from the reverse drive gear 10a to the reverse driven gear 10c via the reverse idler gear 10b and subsequently transmitted from the counter gear 32 to the output shaft 34 via the output gear 36. As a result, the vehicle reverses.

On the other hand, when the first sleeve 38 moves to the side of the first speed drive gear 12a to engage with a first speed clutch gear 42 fixed to the first speed drive gear 12a, the first speed drive gear 12a is connected to the first input shaft 6 such that a first gear is selected.

In this case, when the first clutch C1 is engaged such that the driving force of the engine is transmitted to the first input shaft 6 from the clutch input shaft 2 via the first clutch C1, the driving force of the first input shaft 6 is transmitted from the first speed drive gear 12a to the first speed driven gear 12b and subsequently transmitted from the counter gear 32 to the output shaft 34 via the output gear 36. As a result, the vehicle advances.

Further, the second synchromesh device S2 has a second sleeve 44 which is capable of sliding in the axial direction of the first input shaft 6, and when the second sleeve 44 moves to the side of the fifth speed drive gear 14a to engage with a fifth speed clutch gear 46 fixed to the fifth speed drive gear 14a, the fifth speed drive gear 14a is connected to the first input shaft 6 such that a fifth gear is selected.

In this case, when the first clutch C1 is engaged such that the driving force of the engine is transmitted to the first input shaft 6 from the clutch input shaft 2 via the first clutch C1, the driving force of the first input shaft 6 is transmitted from the fifth speed drive gear 14a to the fifth speed driven gear 14b and subsequently transmitted from the counter gear 32 to the output shaft 34 via the output gear 36. As a result, the vehicle advances.

On the other hand, when the second sleeve 44 moves to the side of the third speed drive gear 16a to engage with a third speed clutch gear 48 fixed to the third speed drive gear 16a, the third speed drive gear 16a is connected to the first input shaft 6 such that a third gear is selected.

In this case, when the first clutch C1 is engaged such that the driving force of the engine is transmitted to the first input shaft 6 from the clutch input shaft 2 via the first clutch C1, the driving force of the first input shaft 6 is transmitted from the third speed drive gear 16a to the third speed driven gear 16b and subsequently transmitted from the counter gear 32 to the output shaft 34 via the output gear 36. As a result, the vehicle advances.

A third synchromesh device S3 that rotates integrally with the second input shaft 8 is disposed between the fourth speed drive gear 24a and the second speed drive gear 26a, and a fourth synchromesh device S4 that rotates integrally with the second input shaft 8 is disposed between the second speed drive gear 26a and the sixth speed drive gear 28a.

The third synchromesh device S3 has a third sleeve 50 which is capable of sliding in an axial direction of the second input shaft 8, and when the third sleeve 50 moves to the side of the fourth speed drive gear 24a to engage with a fourth speed clutch gear 52 fixed to the fourth seed drive gear 24a, the fourth speed drive gear 24a is connected to the second input shaft 8 such that a fourth gear is selected.

In this case, when the second clutch C2 is engaged such that the driving force of the engine is transmitted to the second input shaft 8 from the clutch input shaft 2 via the second clutch C2, the driving force of the second input shaft 8 is transmitted from the fourth speed drive gear 24a to the fourth speed driven gear 24b and subsequently transmitted from the counter gear 32 to the output shaft 34 via the output gear 36. As a result, the vehicle advances.

On the other hand, when the third sleeve 50 moves to the side of the second speed drive gear 26a to engage with a second speed clutch gear 54 fixed to the second speed drive gear 26a, the second speed drive gear 26a is connected to the second input shaft 8 such that a second gear is selected.

In this case, when the second clutch C2 is engaged such that the driving force of the engine is transmitted to the second input shaft 8 from the clutch input shaft 2 via the second clutch C2, the driving force of the second input shaft 8 is transmitted from the second speed drive gear 26a to the second speed driven gear 26b and subsequently transmitted from the counter gear 32 to the output shaft 34 via the output gear 36. As a result, the vehicle advances.

Further, the fourth synchromesh device S4 has a fourth sleeve 56 which is capable of sliding in the axial direction of the second input shaft 8, and when the fourth sleeve 56 moves to the side of the sixth speed drive gear 28a to engage with a sixth speed clutch gear 58 fixed to the sixth speed drive gear 28a, the sixth speed drive gear 28a is connected to the second input shaft 8 such that a sixth gear is selected.

In this case, when the second clutch C2 is engaged such that the driving force of the engine is transmitted to the second input shaft 8 from the clutch input shaft 2 via the second clutch C2, the driving force of the second input shaft 8 is transmitted from the sixth speed drive gear 28a to the sixth speed driven gear 28b and subsequently transmitted from the counter gear 32 to the output shaft 34 via the output gear 36. As a result, the vehicle advances.

A gear is selected by moving the sleeves provided respectively in the synchromesh devices S1, S2, S3, S4 in this manner. The driving force of the engine is transmitted to the first gear mechanism 22 via the first clutch C1, and the driving force of the engine is transmitted to the second gear mechanism 30 via the second clutch C2. Hence, one of the gears can be selected in the second gear mechanism 30 while outputting driving force to the output shaft 34 via one of the gears which has been selected in the first gear mechanism 22 by engaging the first clutch C1 and disengaging the second clutch C2, for example.

Further, by disengaging the first clutch C1 and engaging the second clutch C2, one of the gears can be selected in the first gear mechanism 22 while outputting driving force to the output shaft 34 via one of the gears which has been selected in the second gear mechanism 30.

Hence, in advance of performing a gear change, the predicted gear of the next gear change is selected in the gear mechanism to which the driving force of the engine is not being transmitted at the present time, from among the first gear mechanism 22 and second gear mechanism 30. Subsequently, when a gear change request is issued, the disengaged clutch, from among the first clutch C1 and second clutch C2, is engaged while disengaging the other clutch which has been engaged, and thus driving force can be output from the output shaft 32 continuously, even during a gear change. As a result, the drivability during a gear change can be improved.

Next, a mechanism for moving the first through fourth sleeves 38, 44, 50, 56 of the transmission mechanism 4 selectively when selecting a gear will be described.

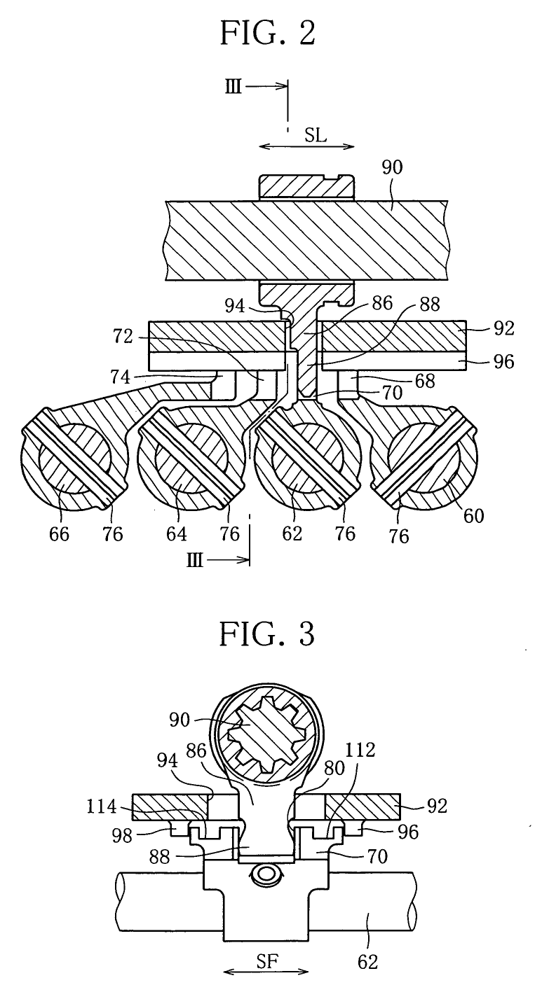

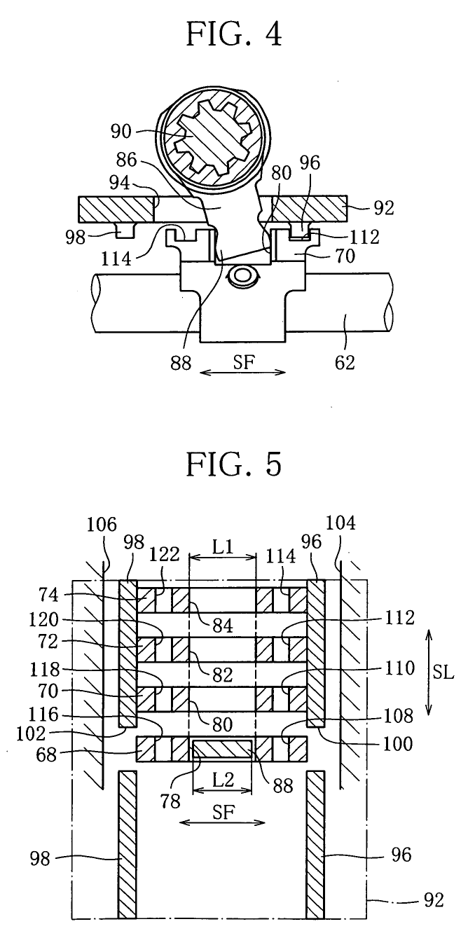

The transmission shown in FIG. 1 is installed in the vehicle with the side of the clutch input shaft 2 being directed toward the front side of the vehicle such that the axial direction of the first input shaft 6 and second input shaft 8 corresponds to the front-rear direction of the vehicle. FIG. 2 is a schematic sectional view showing a mechanism for moving the first through fourth sleeves 38, 44, 50, 56 selectively, seen from the front of the vehicle. FIGS. 3 and 4 are sectional views along a line III-III in FIG. 2, and FIG. 5 is a schematic diagram showing the main parts of the mechanism, seen from above.

As shown in FIG. 2, a first shift rail 60, a second shift rail 62, a third shift rail 64, and a fourth shift rail 66 are disposed parallel to each other in the axial direction of the first input shaft 6 and second input shaft 8.

The first shift rail 60 is connected to the first sleeve 38 of the first synchromesh device S1, and by moving the first shift rail 60 to the front side of the vehicle in the axial direction of the first input shaft 6 and second input shaft 8, i.e. a shifting direction, from a neutral position, i.e. a gear non-selective position, the first sleeve 38 is engaged with the reverse clutch gear 40 of the reverse drive gear 10a, whereby the reverse gear is selected.

On the other hand, when the first shift rail 60 is moved to the rear side of the vehicle in the shifting direction from the neutral position, the first sleeve 38 is engaged with the first speed clutch gear 42 of the first speed drive gear 12a, whereby the first gear is selected.

The second shift rail 62 is connected to the third sleeve 50 of the third synchromesh device S3, and by moving the second shift rail 62 to the front side of the vehicle in the shifting direction from the neutral position, the third sleeve 50 is engaged with the fourth speed clutch gear 52 of the fourth speed drive gear 24a, whereby the fourth gear is selected.

On the other hand, when the second shift rail 62 is moved to the rear side of the vehicle in the shifting direction from the neutral position, the third sleeve 50 is engaged with the second speed clutch gear 54 of the second speed drive gear 26a, whereby the second gear is selected.

Further, the third shift rail 64 is connected to the second sleeve 44 of the second synchromesh device S2, and by moving the third shift rail 64 to the front side of the vehicle in the shifting direction from the neutral position, the second sleeve 44 is engaged with the fifth speed clutch gear 46 of the fifth speed drive gear 14a, whereby the fifth gear is selected.

On the other hand, when the third shift rail 64 is moved to the rear side of the vehicle in the shifting direction from the neutral position, the second sleeve 44 is engaged with the third speed clutch gear 48 of the third speed drive gear 16a, whereby the third gear is selected.

The fourth shift rail 66 is connected to the fourth sleeve 56 of the fourth synchromesh device S4, and by moving the fourth shift rail 66 to the rear side of the vehicle in the shifting direction from the neutral position, the fourth sleeve 56 is engaged with the sixth speed clutch gear 58 of the sixth speed drive gear 28a, whereby the sixth gear is selected.

As shown in FIG. 2, first through fourth shift jaws 68, 70, 72, 74 are disposed close to each other on the first through fourth shift rails 60, 62, 64, 66, respectively, and each fixed by a pin 76. The first through fourth shift jaws 68, 70, 72, 74 correspond to gear change members of the present invention. Further, the first and third shift jaws 68, 72 correspond to a first gear change member of the present invention, while the second and fourth shift jaws 70, 74 correspond to a second gear change member of the present invention.

U-shaped notches 78, 80, 82, 84 are formed in the first through fourth shift jaws 68, 70, 72, 74, respectively, and each of the notches 78, 80, 82, 84 has a width that allows an engaging portion 88 formed on a lower end of a shift lever (shift operating member) 86 to be fitted into each of the notches 78, 80, 82, 84 with play remaining.

A select shaft 90 is disposed above the first through fourth shift rails 60, 62, 64, 66 in such a manner that an axis thereof is oriented in a direction perpendicular to the respective axes of the first through fourth shift rails 60, 62, 64, 66, and the shift lever 86 is mounted to the select shaft 90 with spline-fitting. Thus, the shift lever 86 is capable of sliding in the axial direction of the select shaft 90, and rotation thereof relative to the select shaft 90 about the axis of the select shaft 90 is restricted.

By moving the shift lever 86 in the axial direction of the select shaft 90, the engaging portion 88 is moved in a selecting direction (indicated by an arrow SL) perpendicular to the shifting direction so that the engaging portion 88 can be engaged selectively with one of the notches 78, 80, 82, 84.

Further, the select shaft 90 is capable of rotating about its axis, and when the select shaft 90 rotates, the shift lever 86 swings about the axial center of the select shaft 90.

Hence, for example, when the shift lever 86 moves in the selecting direction indicated by the arrow SL so as to engage with the notch 80 of the second shift jaw 70 with play remaining, and then the select shaft 90 rotates such that the shift lever 86 swings to the rear side of the vehicle in the shifting direction indicated by an arrow SF in FIG. 3, the engaging portion 88 causes the second shift jaw 70 and the second shift rail 62 fixed to the second shift jaw 70 to move to the rear side of the vehicle in the shifting direction, as shown in FIG. 4. As a result, the third sleeve 50 of the third synchromesh device S3 is moved toward the second speed drive gear 26a to engage with the second speed clutch gear 54, as described above, and thus the second gear is selected.

On the other hand, when the shift lever 86 engages with the notch 80 of the second shift jaw 70 with play remaining and then the select shaft 90 rotates such that the shift lever 86 swings to the front side of the vehicle in the shifting direction, the engaging portion 88 causes the second shift jaw 70 and second shift rail 62 to move to the front side of the vehicle in the shifting direction. As a result, the third sleeve 50 of the third synchromesh device S3 is moved toward the fourth speed drive gear 24a to engage with the fourth speed clutch gear 52, as described above, and thus the fourth gear is selected.

Thus, when the shift lever 86 moves in the selecting direction such that the engaging portion 88 engages with one of the notches 78, 80, 82, 84 with play remaining, and then the select shaft 90 rotates such that the shift lever 86 swings in the shifting direction, the shift jaw with which the engaging portion 88 is engaged is moved in the shifting direction, and as a result, the corresponding gear is selected.

Note that movement of the shift lever 86 in the selecting direction and rotation of the select shaft 90 about its axis are executed by shift actuators, not shown in the drawing, which are operated in accordance with shift control performed by a controller, not shown in the drawing.

Measures must be taken to ensure that an inappropriate selection or disengagement of a gear is not performed by preventing a shift jaw other than the shift jaw with which the engaging portion of the shift lever 86 is engaged from moving in the shifting direction.

For this purpose, a lock plate 92 which is capable of moving in the selecting direction via a guide rail extending in the selecting direction, not shown in the drawing, is disposed above the first through fourth shift jaws 68, 70, 72, 74. The shift lever 86 protrudes below the lock plate 92 through a through hole 94 formed in the lock plate 92 so as to be capable of engaging with one of the first through fourth shift jaws 68, 70, 72, 74 in the manner described above.

Thus, when the shift lever 86 moves in the selecting direction, the shift lever 86 contacts the edge portion of the through hole 94, whereby the lock plate 92 moves in the selecting direction together with the shift lever 86. Note that the shifting direction dimension of the through hole 94 is set to be large enough not to obstruct the swinging of the shift lever 86, as shown in FIGS. 3 and 4.

A pair of inhibiting portions 96, 98 projecting from the lower surface of the lock plate 92 are provided along the selecting direction in the vicinity of the first through fourth shift jaws 68, 70, 72, 74 in positions on the outer side of each shifting direction end of each of the first through fourth shift jaws 68, 70, 72, 74 located in the neutral position, i.e. the gear non-selective position.

By disposing the inhibiting portions 96, 98 of the lock plate 92 in this manner, movement of the first through fourth shift jaws 68, 70, 72, 74 in the shifting direction from the neutral position can be inhibited, and therefore the inhibiting portions 96, 98 of the lock plate 92 corresponds to a pair of inhibiting member of the present invention.

Further, grooves 100, 102 are formed in the inhibiting portions 96, 98, respectively, so as to be located corresponding to the shifting direction movement of the shift jaw with which the engaging portion 88 of the shift lever 86 is engaged. The grooves 100, 102 have an enough size to allow the shift lever 86 to move in the shifting direction, and when the shift lever 86 swings, the shift jaw engaged with the engaging portion is capable of moving in the shifting direction through the groove 100 or the groove 102.

FIG. 5 shows a state in which all of the first through fourth shift jaws 68, 70, 72, 74 are in the neutral position, and the engaging portion 88 of the shift lever 86 is located inside the notch 78 of the first shift jaw 68. A width L1 of the notch 78 in the shifting direction is slightly larger than a width L2 of the engaging portion 88 in the shifting direction, and therefore the engaging portion 88 is fitted into the notch 78 with play remaining. Note that the notches 80, 82, 84 of the second through fourth shift jaws 70, 72, 74 also have the shifting direction width L1, similarly to the notch 78 of the first shift jaw 68.

At this time, the inhibiting portions 96, 98 of the lock plate 92, which is indicated by the dot-dash line, are positioned near the two shifting direction ends of the second through fourth shift jaws 70, 72, 74 with which the engaging portion 88 is not engaged, thereby inhibiting movement of the second through fourth shift jaws 70, 72, 74 in the shifting direction.

Meanwhile, the grooves 100, 102 are provided in the inhibiting portions 96, 98 in the shifting direction of the first shift jaw 68 such that when the shift lever 86 swings and the engaging portion 88 moves in the shifting direction, the first shift jaw 68 is moved to a position abutting a stopper 104 on the rear side of the vehicle or a stopper 106 on the front side of the vehicle. Thus, the corresponding gear can be selected.

As described above, when the shift lever 86 moves in the selecting direction, the shift lever 86 abuts against the edge portion of the through hole 94 such that the lock plate 92 moves in the selecting direction together with the shift lever 86. Therefore, the grooves 100, 102 always lie in the shifting direction of the shift jaw with which the engaging portion 88 engages via the corresponding notch. When the shift lever 86 swings, the shift jaw with which the engaging portion 88 engages is moved to a position abutting the stopper 104 or the stopper 106, similarly to the case of the first shift jaw 68 described above, and the corresponding gear is thus selected.

For example, when the engaging portion 88 is located in the notch 78 of the first shift jaw 68 so as to be engaged with the first shift jaw 68, as shown in FIG. 5, and the shift lever 86 is swung such that the engaging portion 88 moves in the shifting direction to the side of the stopper 104, or in other words the rear side of the vehicle, the first shift rail 60 is moved to the rear side of the vehicle together with the first shift jaw 68, whereby the first sleeve 38 engages with the first speed clutch gear 42 and the first gear is selected.

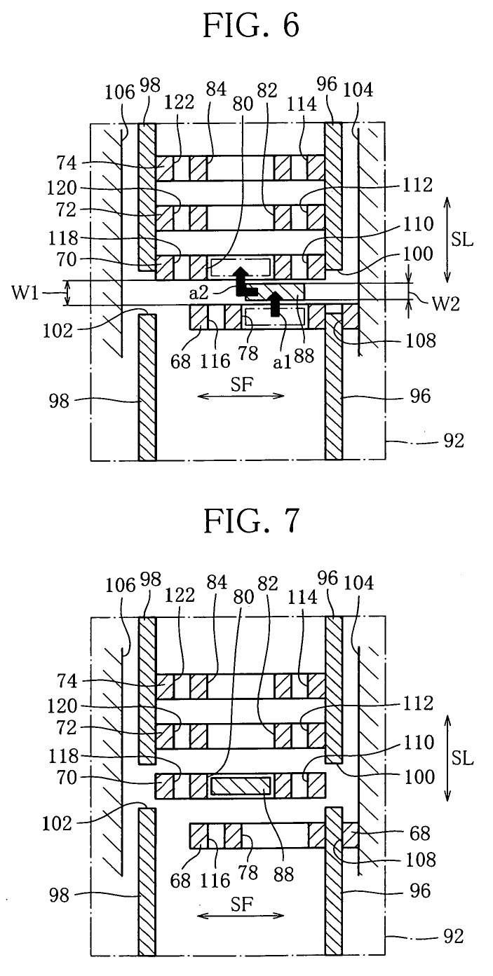

At this time, a recess portion 108 through which the inhibiting member 96 can pass is formed in a position of the first shift jaw 68 corresponding to the selecting direction movement of the inhibiting portion 96 such that when the shift lever 86 is moved in the selecting direction, the inhibiting portion 96, which moves in the selecting direction together with the shift lever 86, is inserted into the recess portion 108, as shown in FIG. 6.

Then, as the shift lever 86 continues to move in the selecting direction, the engaging portion 88 moves in the direction of an arrow a1 in FIG. 6 to be positioned between the first shift jaw 68 and second shift jaw 70.

A gap W1 between the first shift jaw 68 and second shift jaw 70 is set to be larger than a selecting direction thickness W2 of the engaging portion 88 so that the engaging portion 88 can move in the shifting direction between the first shift jaw 68 and second shift jaw 70.

Similarly to the gap between the first shift jaw 68 and second shift jaw 70, a gap between the second shift jaw 70 and third shift jaw 72 and a gap between the third shift jaw 72 and fourth shift jaw 74 are also set at W1, which is larger than the thickness W2 of the engaging portion 88 in the selecting direction, and therefore the engaging portion 88 is capable of moving in the shifting direction between each shift jaw.

As a result, the engaging portion 88 is capable of moving to each shift jaw through the notches 78, 80, 82, 84 and the gaps between the shift jaws regardless of whether the first through fourth shift jaws 68, 70, 72, 74 are in the neutral position, i.e. the gear non-selective position, or a gear selective position.

Hence, the engaging portion 88 can be moved into the notch 80 of the second shift jaw 70 by moving the engaging portion 88 in the selecting direction such that the engaging portion 88 is positioned between the first shift jaw 68 and second shift jaw 70, then swinging the shift lever 86 such that the engaging portion 88 moves to the front side of the vehicle in the shifting direction, as shown by an arrow a2, and subsequently moving the engaging portion 88 in the selecting direction again, as shown in FIG. 6.

As the engaging portion 88 moves in this manner, the inhibiting portions 96, 98 move in the selecting direction while the inhibiting portion 96 is inserted in the recess portion 108 of the first shift jaw 68, and thus the grooves 100, 102 move to positions corresponding to the shifting direction movement of the second shift jaw 70 with which the engaging portion 88 is engaged via the notch 80, as shown in FIG. 7.

Hence, in the state shown in FIG. 7, when the engaging portion 88 is moved in the shifting direction by swinging the shift lever 86 and the second shift jaw 70 is moved in the shifting direction until it abuts against the stopper 106 on the front side of the vehicle, the fourth gear is selected. When the second shift jaw 70 is moved in the shifting direction until it abuts against the stopper 104 on the rear side of the vehicle, the second gear is selected.

In this state, the inhibiting member 96 is inserted in the recess portion 108 of the first shift jaw 68, and therefore, even if the first shift jaw 68 with which the engaging portion 88 is not engaged attempts to move in the shifting direction for some reason, movement of the first shift jaw 68 in the shifting direction is inhibited by the engagement between the recess portion 108 and inhibiting portion 96. As a result, a situation in which the first gear, which is selected when the first shift jaw 68 is in a position abutting against the stopper 104, is disengaged unintentionally does not arise.

Similar recess portions 110, 112, 114 to the recess portion 108 of the first shift jaw 68 are provided in the second through fourth shift jaws 70, 72, 74, and when the engaging portion 88 moves in the selecting direction while one of the second through fourth shift jaws 70, 72, 74 is in the gear selective position abutting the stopper 104, the inhibiting portions 96, 98 are capable of moving in the selecting direction while the inhibiting portion 96 is inserted in the recess portion of the shift jaw in the gear selective position.

Further, movement of the shift jaw in the gear selective position abutting the stopper 104, with which the engaging portion is not engaged, in the shifting direction is inhibited by the engagement between the recess portion of the concerned shift jaw and the inhibiting portion 96, and therefore a situation in which the gear selected by the concerned shift jaw is disengaged unintentionally does not arise.

Meanwhile, recess portions 116, 118, 120, 122 having a similar shape to the recess portions 108, 110, 112, 114 are provided in the first through fourth shift jaws 68, 70, 72, 74 in positions on the opposite side of the notches 78, 80, 82, 84 from the recess portions 108, 110, 112, 114 so that when one of the first through fourth shift jaws 68, 70, 72, 74 is in the gear selective position abutting the stopper 106, movement of the inhibiting portion 98 in the selecting direction is permitted.

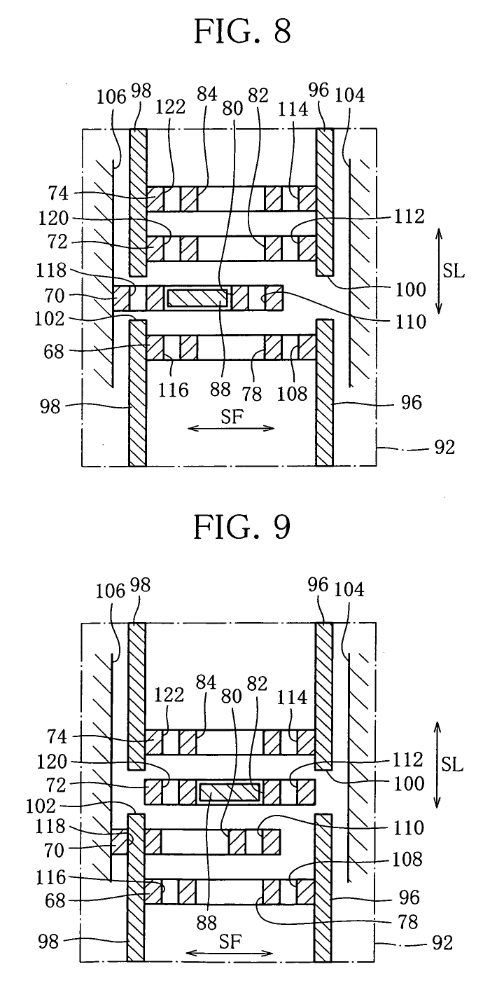

For example, when the shift lever 86 is moved in the selecting direction from the state shown in FIG. 5 such that the engaging portion 88 is moved into the notch 80 of the second shift jaw 70, the inhibiting portions 96, 98 move in the selecting direction together with the engaging portion 88, whereby the grooves 100, 102 move to be located in the shifting direction from the second shift jaw 70. Thus, the engaging portion 88 can be moved in the shifting direction to the stopper 106 on the front side of the vehicle by swinging the shift lever 86, as shown in FIG. 8. As described above, by moving the second shift jaw 70 in this manner, the fourth gear is selected.

At this time, the recess portion 118 through which the inhibiting portion 98 can pass is positioned in a position of the second shift jaw 70 corresponding to the selecting direction movement of the inhibiting portion 98 such that when the shift lever 86 is moved in the selecting direction, the inhibiting portion 98, which moves in the selecting direction together with the shift lever 86, is inserted into the recess portion 118.

Hence, the engaging portion 88 can be moved into the notch 82 of the third shift jaw 72 by moving the shift lever 86 in the selecting direction such that the engaging portion 88 is positioned between the second shift jaw 70 and third shift jaw 72, then moving the engaging portion 88 to the rear side of the vehicle in the shifting direction, and subsequently moving the engaging portion 88 in the selecting direction again.

As the engaging portion 88 moves in this manner, the inhibiting portions 96, 98 move in the selecting direction while the inhibiting portion 98 is inserted in the recess portion 118 of the second shift jaw 70, and hence, when the engaging portion 88 is located in the notch 82, as shown in FIG. 9, the grooves 100, 102 move to positions located corresponding to the shifting direction movement of the third shift jaw 72.

Accordingly, when the engaging portion 88 is moved in the shifting direction by swinging the shift lever 86 from this state, and the third shift jaw 72 is moved until it abuts against the stopper 104, the third gear is selected, and when the third shift jaw 72 is moved until it abuts against the stopper 106, the fifth gear is selected.

In this state, the inhibiting member 98 is inserted in the recess portion 118 of the second shift jaw 70, and therefore, even if the second shift jaw 70 with which the engaging portion 88 is not engaged attempts to move in the shifting direction for some reason, movement of the second shift jaw 70 in the shifting direction is inhibited by the engagement between the recess portion 118 and the inhibiting portion 98. As a result, a situation in which the fourth gear, which is selected when the second shift jaw 70 is in a position abutting against the stopper 106, is disengaged unintentionally does not arise.

The relationships between the inhibiting portion 98 and the recess portions 116, 120, 122 of the first, third, and fourth shift jaws 68, 72, 74 are similar to the relationship between the inhibiting portion 98 and the recess portion 118 of the second shift jaw 70, and therefore, when the engaging portion 88 moves in the selecting direction while one of the first through fourth shift jaws is in the gear selective position abutting the stopper 104, the inhibiting portions 96, 98 can move in the selecting direction while the inhibiting portion 98 is inserted into the recess portion of the shift jaw that is in the gear selective position.

Furthermore, movement of the shift jaw in the gear selective position abutting the stopper 106, with which the engaging portion is not engaged, in the shifting direction is inhibited by the engagement between the recess portion of the concerned shift jaw and the inhibiting portion 98, and therefore the gear selected by the concerned shift jaw is not disengaged unintentionally.

By providing the recess portions 108, 110, 112, 114, 116, 118, 120, 122 in the first through fourth shift jaws 68, 70, 72, 74 in this manner, when the first shift jaw 68 has been moved to the stopper 104 and the shift lever 86 moves in the selecting direction, the inhibiting portion 96 moves in the selecting direction through the recess portion 108 of the first shift jaw 68. When the engaging portion 88 is not positioned in the notch 78 of the first shift jaw 68 at this time, movement of the first shift jaw 68 in the shifting direction is inhibited by the engagement between the recess portion 108 and the inhibiting portion 96, and therefore the gear selected by the first shift jaw 68 is not disengaged unintentionally.

On the other hand, when the first shift jaw 68 has been moved to the stopper 106 and the shift lever 86 moves in the selecting direction, the inhibiting portion 98 moves in the selecting direction through the recess portion 116 of the first shift jaw 68. When the engaging portion 88 is not positioned in the notch 78 of the first shift jaw 68 at this time, movement of the first shift jaw 68 in the shifting direction is inhibited by the engagement between the recess portion 116 and the inhibiting portion 98, and therefore the gear selected by the first shift jaw 68 is not disengaged unintentionally.

Further, when the second shift jaw 70 has been moved to the stopper 104 and the shift lever 86 moves in the selecting direction, the inhibiting portion 96 moves in the selecting direction through the recess portion 110 of the second shift jaw 70. When the engaging portion 88 is not positioned in the notch 80 of the second shift jaw 70 at this time, movement of the second shift jaw 70 in the shifting direction is inhibited by the engagement between the recess portion 110 and the inhibiting portion 96, and therefore the gear selected by the second shift jaw 70 is not disengaged unintentionally.

On the other hand, when the second shift jaw 70 has been moved to the stopper 106 and the shift lever 86 moves in the selecting direction, the inhibiting portion 98 moves in the selecting direction through the recess portion 118 of the second shift jaw 70. When the engaging portion 88 is not positioned in the notch 80 of the second shift jaw 70 at this time, movement of the second shift jaw 70 in the shifting direction is inhibited by the engagement between the recess portion 118 and the inhibiting portion 98, and therefore the gear selected by the second shift jaw 70 is not disengaged unintentionally.

Further, when the third shift jaw 72 has been moved to the stopper 104 and the shift lever 86 moves in the selecting direction, the inhibiting portion 96 moves in the selecting direction through the recess portion 112 of the third shift jaw 72. When the engaging portion 88 is not positioned in the notch 82 of the third shift jaw 72 at this time, movement of the third shift jaw 72 in the shifting direction is inhibited by the engagement between the recess portion 112 and the inhibiting portion 96, and therefore the gear selected by the third shift jaw 72 is not disengaged unintentionally.

On the other hand, when the third shift jaw 72 has been moved to the stopper 106 and the shift lever 86 moves in the selecting direction, the inhibiting portion 98 moves in the selecting direction through the recess portion 120 of the third shift jaw 72. When the engaging portion 88 is not positioned in the notch 82 of the third shift jaw 72 at this time, movement of the third shift jaw 72 in the shifting direction is inhibited by the engagement between the recess portion 120 and the inhibiting portion 98, and therefore the gear selected by the third shift jaw 72 is not disengaged unintentionally.

Further, when the fourth shift jaw 74 has been moved to the stopper 104 and the shift lever 86 moves in the selecting direction, the inhibiting portion 96 moves in the selecting direction through the recess portion 114 of the fourth shift jaw 74. When the engaging portion 88 is not positioned in the notch 84 of the fourth shift jaw 74 at this time, movement of the fourth shift jaw 74 in the shifting direction is inhibited by the engagement between the recess portion 114 and the inhibiting portion 96, and therefore the gear selected by the fourth shift jaw 74 is not disengaged unintentionally.

On the other hand, when the fourth shift jaw 74 has been moved to the stopper 106 and the shift lever 86 moves in the selecting direction, the inhibiting portion 98 moves in the selecting direction through the recess portion 122 of the fourth shift jaw 74. When the engaging portion 88 is not positioned in the notch 84 of the fourth shift jaw 74 at this time, movement of the fourth shift jaw 74 in the shifting direction is inhibited by the engagement between the recess portion 122 and the inhibiting portion 98, and therefore the gear selected by the fourth shift jaw 74 is not disengaged unintentionally.

Hence, the inhibiting portions 96, 98 are capable of moving in the selecting direction as the shift lever 86 moves in the selecting direction, regardless of whether the first through fourth shift jaws 68, 70, 72, 74 are in the neutral position, i.e. the gear non-selective position, or the gear selective position abutting the stopper 104 or the stopper 106.

Further, by positioning the inhibiting members 96, 98 near the two shifting direction ends of a shift jaw in the gear non-selective position, with which the engaging portion 88 is not engaged, movement of the concerned shift jaw in the shifting direction is restricted, and by inserting the inhibiting portion 96 or the inhibiting portion 98 in the recess portion of a shift jaw in the gear selective position, with which the engaging portion 88 is not engaged, movement of the concerned shift jaw in the shifting direction is inhibited.

Hence, situations in which a different gear to the gear to be selected is unintentionally selected or a selected gear is unintentionally disengaged do not occur.

On the other hand, a shift jaw with which the engaging portion 88 is engaged can move in the shifting direction without being inhibited by the inhibiting portions 96, 98 due to the grooves 100, 102 that move in the selecting direction in conjunction with the engaging portion 88.

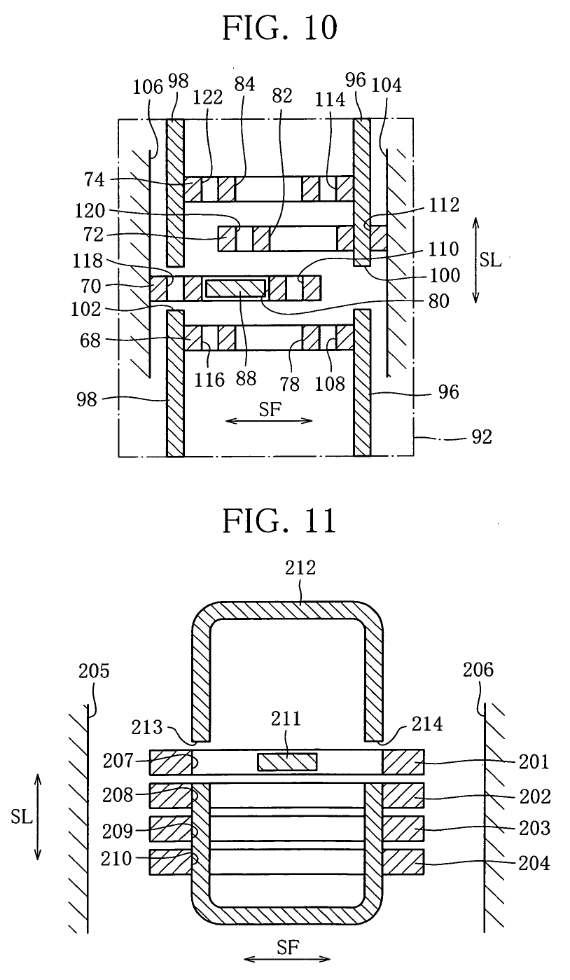

For example, FIG. 10 shows a state in which the fourth gear has been selected by moving the second shift jaw 70 in the shifting direction to the stopper 106, and the third gear has been selected by moving the third shift jaw 72 to the stopper 104.

In this case, the engaging portion 88 is located in the notch 80 of the second shift jaw 70, and therefore the grooves 100, 102 are positioned correspondingly in the shifting direction from the second shift jaw 70. Hence, the second shift jaw 70 is capable of moving in the shifting direction.

Meanwhile, the first shift jaw 68, third shift jaw 72, and fourth shift jaw 74 are not engaged with the engaging portion 88, and the inhibiting portions 96, 98 are positioned on the two shifting direction ends of the first shift jaw 68 located in the neutral position, i.e. the gear non-selective position. Therefore, movement of the first shift jaw 68 in the shifting direction is inhibited.

Further, movement of the third shift jaw 72, which is in the gear selective position, in the shifting direction is inhibited due to the inhibiting portion 96 being inserted in the recess portion 116, and movement of the fourth shift jaw 74, which is in the neutral position, in the shifting direction is inhibited due to the inhibiting portions 96, 98 being positioned at the two shifting direction ends thereof, similarly to the first shift jaw 68.

Hence, when a shift jaw that is not engaged with the engaging portion 88 is positioned in the gear selective position, movement thereof in the shifting direction is inhibited due to the inhibiting portion 96 or the inhibiting portion 98 being inserted in the recess portion, and when a shift jaw that is not engaged with the engaging portion 88 is positioned in the gear non-selective position, movement thereof in the shifting direction is inhibited due to the inhibiting portions 96, 98 being positioned at the two shifting direction ends thereof.

As a result, shifting direction movement of the shift jaws that are not engaged with the engaging portion 88 and are not required to modify the gear selection state can be inhibited, so that inappropriate gear selection and disengagement do not occur.

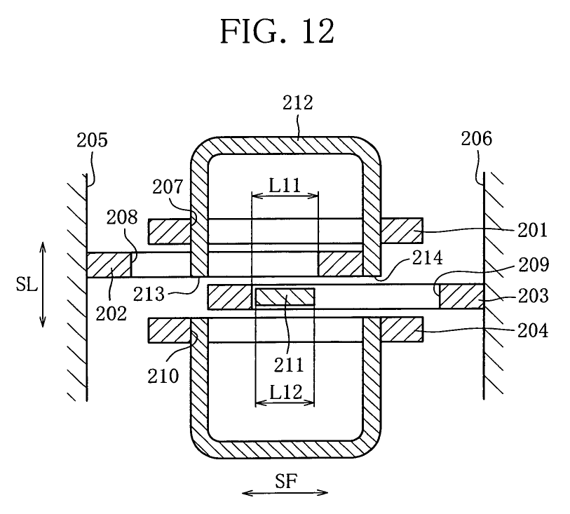

Further, as described above, shifting direction movement of shift jaws in the gear non-selective position is inhibited due to the inhibiting portions 96, 98 being positioned at the two shifting direction ends thereof, and hence the shifting direction dimension of the notches can be reduced in comparison with a device such as the interlocking mechanism shown in FIGS. 11 and 12, in which the inhibiting member abuts the shift jaw within the notch. As a result, the shifting direction dimension of the first through fourth shift jaws 68, 70, 72, 74 can also be reduced, enabling a reduction in the shifting direction space required to accommodate the first through fourth shift jaws 68, 70, 72, 74 and ensuring that increases in the length of the transmission can be prevented.

In this embodiment, the gap W1 between each shift jaw is larger than the thickness W2 of the engaging portion 88 in the selecting direction, as described above, and therefore the engaging portion 88 can be moved to the desired notch even when one of the first through fourth shift jaws 68, 70, 72, 74 is in the gear selective position abutting the stopper 104 and one of the other shift jaws is in the gear selective position abutting the stopper 106.

Since the shifting direction width L1 of the notches 78, 80, 82, 84 need only be slightly larger than the shifting direction width L2 of the engaging portion 88 so that the engaging portion 88 can be fitted into one of the notches 78, 80, 82, 84 with play remaining, the shifting direction dimension of the first through fourth shift jaws 68, 70, 72, 74 can also be reduced to the required minimum.

Further, the shifting direction play between the engaging portion 88 and engaged one of the notches 78, 80, 82, 84 is small, and therefore the swinging radius of the shift lever 86 can be reduced. As a result, increases in the height direction size of the transmission can be prevented, the operating force required to operate the shift lever 86 can be reduced, and the actuator used to operate the shift lever 86 can be downsized.

The transmission according to one embodiment of the present invention has been described above, but the present invention is not limited to this embodiment.

For example, in the embodiment described above, the gap W1 between each shift jaw is made larger than the selecting direction thickness W2 of the engaging portion 88 so that the engaging portion 88 can move between the shift jaws in the shifting direction. However, the present invention does not necessarily have to be constituted in this manner.

More specifically, the gap between each shift jaw may be narrowed while determining the shifting direction width of the notches 78, 80, 82, 84 such that the shifting direction width of the region in which the notches 78, 80, 82, 84 overlap each other in the selecting direction is larger than the shifting direction width of the engaging portion 88. In this case, the gap between the notches 78, 80, 82, 84 and the engaging portion 88 increases, and therefore, the shifting direction dimension of the first through fourth shift jaws 68, 70, 72, 74 increases in comparison with the embodiment described above. However, the shifting direction dimension of the first through fourth shift jaws 68, 70, 72, 74 can be shortened in comparison with that of a device in which the inhibiting member is disposed inside the notch.

Furthermore, in the embodiment described above, the effects of the present invention are maximized by making the shifting direction width L1 of the notches 78, 80, 82, 84 formed in the first through fourth shift jaws 68, 70, 72, 74 similar to, but slightly larger than, the shifting direction width L2 of the engaging portion 88 so that the engaging portion 88 can be fitted into the notches 78, 80, 82, 84 with play remaining. However, if there is surplus space in the shifting direction, the shifting direction width L1 of the notches 78, 80, 82, 84 does not necessarily have to be reduced to the vicinity of the shifting direction width L2 of the engaging portion 88. Note, however, that by reducing the shifting direction width L1 of the notches 78, 80, 82, 84, a greater effect can be obtained with respect to the shifting direction space and the operating force applied to the shift lever 86.

Furthermore, in the embodiment described above, the transmission, in which the driving force of the engine can be transmitted to the first gear mechanism 22 via the first clutch C1 and to the second gear mechanism 30 via the second clutch C2, is constituted such that a gear of the first gear mechanism 22 and a gear of the second gear mechanism 30 are selected simultaneously, but the number and constitution of the clutches and the number and constitution of the gear mechanisms are not limited to those described above, and the present invention may be applied to any transmission in which, at least, a gear can be selected by moving a gear change member while a shift operating member is engaged with the gear change member.

Accordingly, in a transmission such as that described in the above embodiment, the number of gears is not limited to six, and the present invention can be applied similarly to a transmission having a smaller or larger number of gears as required. Moreover, the combinations of gears and synchromesh devices and the arrangement of the shift jaws may be modified appropriately.

Further, in the embodiment described above, the first input shaft 6 and second input shaft 8 are disposed coaxially, but the two input shafts may be disposed separately so as to be parallel with each other.

Furthermore, in the embodiment described above, the first gear mechanism 22 is formed between the first input shaft 6 and the countershaft 16, the second gear mechanism 30 is formed between the second input shaft 8 and the countershaft 20, and the driving force transmitted to the countershaft 20 is output to the output shaft 34 via the output gear 36 that meshes with the counter gear 32. However, driving force transmission between the input shaft and output shaft is not limited to this example, and a plurality of countershafts may be provided, for example.

Furthermore, in the embodiment described above, the shift lever 86 is spline-fitted to the select shaft 90, and by sliding the shift lever 86 in the axial direction of the select shaft 90, the shift lever 86 is moved in the selecting direction. However, the shift lever 86 may be fixed to the select shaft 90, and the shift lever 86 may be moved in the selecting direction by moving the select shaft 90 in the axial direction using a shift actuator.

As regards rotation of the shift lever 86 about the axis of the select shaft 90, the shift lever 86 may be made capable of rotating about the axis of the select shaft 90 without being spline-fitted to the select shaft 90. In this case, the shift lever 86 may be swung by a shift actuator.

Furthermore, in the embodiment described above, gear selection is performed by moving the first through fourth shift rails 60, 62, 64, 66 to which the first through fourth shift jaws 68, 70, 72, 74 are fixed, thereby forming the gear change members of the present invention, in the shifting direction, but the form of the gear change members is not limited to this example.

For example, the first through fourth shift jaws may be capable of sliding relative to the first through fourth shift rails, and the first through fourth sleeves may be moved by connecting the first through fourth shift jaws to the first through fourth sleeves respectively using links.

Furthermore, in the embodiment described above, an engine is used as the power source, but it goes without saying that a power source other than an engine, such as an electric motor, may be used instead.

Signs used in the embodiment are defined as follows.

4 transmission mechanism; 6 first input shaft; 8 second input shaft; 22 first gear mechanism; 30 second gear mechanism; 36 output shaft; 60 first shift rail (first gear change member); 62 second shift rail (second gear change member); 64 third shift rail (first gear change member); 66 fourth shift rail (second gear change member); 68 first shift jaw (first gear change member); 70 second shift jaw (second gear change member); 72 third shift jaw (first gear change member); 74 fourth shift jaw (second gear change member); 78, 80, 82, 84 notches; 86 shift lever (shift operating member); 88 engaging portion; 92 lock plate; 96, 98 inhibiting portions (inhibiting members); 100, 102 grooves; 108, 110, 112, 114, 116, 118, 120, 122 recess portions; C1 first clutch; and C2 second clutch.

1. A transmission comprising:
a plurality of gear change members arranged for moving from a gear non-selective position to a gear selective position in a predetermined shifting direction to select a gear of a transmission mechanism;
a shift operating member capable of moving in a selecting direction perpendicular to the shifting direction to engage with one of the gear change members, and of causing the gear change member with which the shift operating member is engaged to move in the shifting direction; and
a pair of inhibiting members disposed along the selecting direction on an outer side of each shifting direction end of each of said plurality of gear change members located in the gear non-selective position in order to be able to inhibit movement of the gear change members in the shifting direction, each inhibiting member being capable of moving in the selecting direction together with the shift operating member, and each inhibiting member being formed with a groove that allows the gear change member which is selected from among the plurality of gear change members and is engaged with the shift operating member to move in the shifting direction,
wherein each of the gear change members is provided with recess portions arranged for allowing the pair of inhibiting members to move in the selecting direction when the corresponding gear change member is located in the gear selective position, and for inhibiting the corresponding gear change member from moving to the gear non-selective position by engaging with one of the inhibiting members when the corresponding gear change member is located in the gear selective position and not engaged with the shift operating member.

2. The transmission according to claim 1, wherein the shift operating member comprises an engaging portion arranged for engaging with one of the gear change members, and
a notch is provided in each of the gear change members for enabling passage of the engaging portion therethrough when the shift operating member moves in the selecting direction and for engaging with the engaging portion when the shift operating member moves in the shifting direction,
wherein a width of each of the notches in the shifting direction is set to be larger than, and similar to, a width of the engaging portion in the shifting direction so that the engaging portion can be fitted into one of the notches with play remaining.

3. The transmission according to claim 1, wherein the transmission mechanism comprises:
a first input shaft to which a driving force from a power source is transmitted via a first clutch;
a second input shaft to which the driving force is transmitted via a second clutch;
an output shaft arranged for outputting the driving force following speed shifting thereof;
a first gear mechanism provided between the first input shaft and the output shaft, and having a plurality of gears; and
a second gear mechanism provided between the second input shaft and the output shaft, and having a plurality of gears,
wherein the gear change members are constituted by a first gear change member arranged for selecting a gear of the first gear mechanism, and a second gear change member arranged for selecting a gear of the second gear mechanism.
